(19) United States
(12) Patent Application Publication
(10) Pub. No.: US 2010/0020756 A1
(43) Pub. Date: Jan. 28, 2010

(54) DYNAMICALLY TRANSFORMED CHANNEL SET QUALITY OF SERVICE

(75) Inventor: Robert A. Kennedy, Austin, TX (US)

Correspondence Address: FELDMANGALE, P.A., 1700 Market Street, Suite # 3130, Philadelphia, PA, 19103, US

(73) Assignee: Adapt4, LLC, Melbourne, FL (US)

(21) Appl. No.: 12/508,952

(22) Filed: Jul. 24, 2009

Related U.S. Application Data
(60) Provisional application No. 61/083,420, filed on Jul. 24, 2008.

(51) Int. Cl. H04W 72/00

(52) U.S. Cl. 370/329

(57) ABSTRACT

Systems and methods of the present invention enable the provisioning of QoS over a true multichannel mobile ad hoc network. The QoS framework of the present invention optimizes QoS performance across many channels simultaneously by treating the many channels like a single channel for purposes of QoS optimization. Aspects of the invention that allow the true multichannel provisioning of QoS include use of the physical layer to select available channels, firm state QoS functionality, hybrid signaling, dynamic associative multi-spectral queuing, and cross-layer communication of node information for use by QoS service.

### CROSS REFERENCE TO RELATED APPLICATIONS

The present invention claims the benefit of U.S. Patent Provisional Application No. 61/083,420, filed Jul. 24, 2008, by Robert A. Kennedy, entitled “Dynamically Transformed Channel Set Quality Of Service,” the disclosure of which is incorporated herein. The following are incorporated herein by reference: U.S. Pat. No. 7,457,295; U.S. Patent Publication No. 20090074033; U.S. patent application Ser. No. 11/532,306; U.S. Patent Provisional Application No. 61/121,797; and U.S. patent application Ser. No. 12/501,921.

### FIELD OF THE INVENTION

The present invention relates to the field of communication networks, and more particularly, to mobile ad hoc wireless networks, general mesh networks, wireless sensor networks and related methods.

### BACKGROUND OF THE INVENTION

Ad hoc networks are self-forming networks which can operate in the absence of any fixed infrastructure. An ad hoc network may typically include a number of geographically-distributed, potentially mobile units, sometimes referred to as “nodes,” which are wirelessly connected to each other by one or more links such as, for example, radio frequency communication channels. The nodes can communicate with each other over a wireless channel without the support of an infrastructure-based or wired network.

Links or connections between the nodes in the network can change dynamically in an arbitrary manner as nodes move in and out of, or within the ad hoc network. Because the topology of an ad hoc network can change significantly, techniques are needed which can allow the ad hoc network to dynamically adjust to these changes. Due to the lack of a central server-controller, many network-controlling functions can be distributed among the nodes such that the nodes can self-organize and reconfigure in response to spectrum topology changes.

Most traditional radios have their technical characteristics set at the time of manufacture. More recently, radios have been built to self-adapt to one of several preprogrammed radio frequency (RF) environments that might be encountered. Cognitive radios (“CRs”) go beyond preprogrammed settings to operate both in known and unknown wireless channels.

CRs have emerged on the forefront of communications technology for those seeking radios capable of conducting quality communications over decreasingly-available RF spectrum due to many more users requiring larger amounts of spectrum for wireless voice, video and data. A CR determines where in the spectrum it can transmit and receive and where it can spectrally move to in the event it can no longer utilize frequency channels that it has been using due to poor channel quality or to being preempted by a primary user or higher priority secondary user.

Two very different approaches have arisen to equip advanced, opportunistic radios with the necessary technological core: geo-location and spectrum sensing. The first approach is called spectrum sensing. CRs that employ spectrum sensing technologies listen for or sense currently unoccupied channels to carry the traffic of the CR. An opportunistic radio in the spectrum sense is one that will try to utilize any available RF spectrum that it can find currently unoccupied and, if operating in a licensed or government regulated band, has a legal government license to use. Geo-location approaches utilize location information of primary users (e.g., television stations, public safety teams) as provided by GPS, for example, to dictate the actual geographical area where opportunistic radios wanting to conduct communications cannot interfere.

Most modern real world applications require at least three CRs communicating with each other to form a wireless network. A cognitive radio equipped with the ability to initiate and maintain networked communications with other CRs, even as each CR is dynamically adjusting the channel(s) it operates on, is referred to as a Cognitive Networking Radio (CNR). CNR in general has to do with the radio being fully aware of: 1) who it is, including all of its characteristics (functionality, physical properties and limitations, etc.); and 2) who the users are and their applications and/or missions. CNR involves the radio not only being fully aware of things, but also having a deep enough understanding of the meaning or context of this information in order to allow it to optimize its performance and functionality to satisfy the requirements of the network, applications and users.

It is well-known today that manufacturing a cognitive radio and manufacturing a cognitive networking radio are two very different things. A cognitive radio may be defined as a wireless network node that changes its transmission and reception configuration to avoid interference signals from other users or devices. The cognitive radio monitors its environment within its allotted frequency bands and changes the frequencies or bands over which it operates based on the accessibility to those frequencies. On the other hand, a CNR performs all the functions of a cognitive radio but it also interacts with the networking-specific components and services (routing, quality of service “QoS”, network management, etc.) of both itself and other nodes.

A mobile ad hoc network (MANET) is characterized by the lack of fixed networking infrastructure such as routers, switches, base stations and mobile switching centers in the traditional cellular sense. User nodes (radios) are in general also routers and vice versa. A MANET node is most often battery limited. Also, a MANET's network topology is usually dynamically changing with nodes coming in and going out of the network and with links being established and broken. A node while technically still within the geographic boundaries of the network, may experience a break off in connections to it because of internal node or link failures.

A fully-connected mesh network is one in which there are at least two paths to each node. Partially-connected mesh networks will have some nodes with only one path to them. “Connected” in this case does not have to be limited to each node's nearest one-hop neighbors. It also allows for nodes to be “connected” via multiple hops to all other nodes in the network. Although often used interchangeably in the art, the present application does not define a MANET and a mesh network as one and the same thing. A MANET involves nodes that form a mesh (partial or full), but also may be in motion and have an ad hoc nature or a deterministic or random basis. Although it may be stretching the tolerance of most network engineers, point-to-point, point-to-multipoint and mesh networks (static or mobile) may be thought of as trivial cases of MANETs. As it is now, Bluetooth scatternets are often referred to as ad hoc networks, but again they are just very trivial cases of MANETs. A more detailed description of MANETs and cross-layer communications in MANETs can be found in different documents made available, for example, by the Ubiquitous Internet Research Group through their website (http://cnd.iit.cnr.it/). One such document is entitled “MOBILEMAN, Architecture, Protocols, and Services,” Deliverable D5, by Marco Conti et al. See: http://cnd.iit.cnr.it/mobileMAN/deliverables/MobileMAN_Deliverable_D5.pdf

One of the most difficult problems in networking is that of delivering the performance required of the classes of service (COS) for all of the various users of the network. Complying with QoS requirements has always been a challenging problem even in wired networks. The advent of wireless types of networks such as cellular, WiFi, Bluetooth and Low-Rate Personal Area Networks (LRPANS, a.k.a. 802.15.4lZigbee) presents far more difficult problems for providing acceptable QoS than do the wired networks. A person of ordinary skill in the art would recognize that providing an acceptable QoS is even more challenging.

Conventionally, network traffic engineers have two complimentary approaches available for achieving QoS. These approaches, which are designed for use in combination in different network contexts, are reservation-based engineering and reservation-less engineering.

Reservation-based engineering relates to the apportionment of network resources according to an application's QoS request. The apportionment is subject to bandwidth management policy. This approach has been used as the method of achieving QoS in RSVP-IntServ.

In reservation-less engineering, as the name implies, no reservation is done within the network. The addition of “smart” mechanisms into the network, for example Connection Admission Control (CAC), Policy Managers, Traffic Classes, and Queuing Mechanisms, enables the network to achieve QoS. CAC may be defined as a mechanism that controls which nodes can access the network and that assures that once a node is grated access to the network, it will be served with the QoS parameters it is requesting. Policy Managers may be defined as mechanisms that ensure that no node will violate the type of service pre-assigned to it. Traffic Classes (e.g., assured, controlled-load or best-effort services) may be defined as mechanisms that differentiate the processing priority of data packets. The reservation-less engineering approach has been used in the DiffServ (Differentiated Services) QoS architecture. In DiffServ, a short bit-pattern in each packet is used to mark the packet for purposes of assigning to the packet a particular forwarding treatment, or per-hop behavior, at each network node. The short bit patterns are written in the IPv4 TOS octet or the IPv6 Traffic Class octet. To avoid or reduce congestion, queuing mechanisms in general may either drop packets with the lowest priority or provide feedback to nodes.

The IntServ approach for achieving QoS is not a workable solution for MANETs because of the inherent resource limitations in MANETs. Particularly, there are several factors which impede the implementation of the IntServ approach in a MANET, for example, the extremely large storage and processing overhead for each mobile node, since nodes would have to build and maintain such information; IntServ's reservation and maintenance process is a network consuming procedure. In an IntServ architecture, signaling packets compete with the data packets for resources and more importantly for bandwidth. The reason for this is that IntServ uses an out-of-band signaling protocol. I

Another impediment to implementing IntServ in MANETs relates to the implementation of a Connection Admission Control. In order to have a complete QoS model infrastructure such as CAC, the network services must provide classification and scheduling, which in turn require a great amount of network resources which are usually not available in MANETs.

FIG. 1 illustrates an exemplary network 100 implementing DiffServ. The exemplary network 100 includes a plurality of routers 103 at the core of the network, with a large number of flows 105 in between. The network 100 also includes routers 107 at the edge of the network, with few flows established between the routers 107 and the core of the network 100.

Unlike IntServ, DiffServ is considered a lightweight model for the interior routers as individual state flows are aggregated 101 into a set of flows (see FIG. 1). This results in the routing to be more easily conducted in the core of the network 100, for example.

Because of the dynamic network topology, in MANETs there is no clear core, ingress or egress routers. This factor impedes the proper application of DiffServ to MANETs. Also, Service Level Agreements (SLA), the contract between the customer (for example ISPs) and the clients, while applicable in Wire-based QoS frameworks, is not applicable to MANETs.

Flexible QoS Model for MANETs (FQMM), was the first QoS model/framework proposed for MANETs. FQMM applies solutions offered in the wire-based networks a QoS framework which considers the characteristics of MANETs. FQMM uses both the per-flow state property of IntServ and the service differentiation of DiffServ. Specifically, FQMM assigns the highest priority based on per flow provisioning, while other priority classes are given per-class provisioning.

FQMM assumes that not all packets in the network request the highest priority. As illustrated in FIG. 5, the FQMM model defines three types of nodes (as in DiffServ) ingress (node 1 in 501 and 2 in 503); core/interior (2,3, and 6 in 501, and 3 in 503); and egress (7 in 501 and 6 in 503). The difference between these definitions is that in FQMM the type of node does not relate to the physical location of that node in the network. Defining the type node in MANET based on the physical location is not practical as the network topology is dynamic. In FQMM, a node is characterized as ingress if it is the source of the data, the core is characterized as the node(s) forwarding data, and egress is defined as the destination of the data. One of the major weaknesses with FQMM is that it cannot deliver the required QoS across a dynamic, spectrally non-contiguous set of channels.

Each of the types of networks mentioned above has at least one general parameter in common that measures the difficulty in delivering QoS—the “degrees of freedom” of the network nodes. Degrees of freedom may be defined as the number of network-affecting parameters that may change in value or behavior. Wired networks have the fewest degrees of freedom. Wired networks can depend on the nodes being in the same specific geographical location and connected to the same wired infrastructure under very controlled, managed conditions.

The next class of networks, including WiFi, cellular, satellite, Bluetooth and LRPANs, has many more degrees of freedom primarily due to the “wirelessness” and mobility of the class. However, each of these networks still relies on a fixed backbone infrastructure. Thus, although being wireless and somewhat mobile does typically result in lower link bandwidths and higher bit error rates (BER), the presence of a fixed infrastructure still gives these wireless networks a set of relatively dependable nodes at which network control and management can be conducted.

The complications for MANETs arise not only because they have the degrees of freedom of the basic wireless networks above (with the possible exception of the great distance degree of freedom of satellite), but they also lack the fixed infrastructure, i.e., nodes come and go possibly at random (the ad hoc nature), and any node is able to take on routing roles. This makes every standardized network protocol such as TCP, RIP, BGP, OSPF, EIGRP, etc., virtually of no use in a MANET, as these protocols depend on having the more limited set of degrees of freedom of conventional wired and wireless networks. However, all of these networks use one, two or even a greater number of fixed spectral channels that provide a well-defined boundary over which to operate. In addition, QoS operates on only one spectral channel at a time. That is, current QoS approaches are only focused on optimizing QoS performance on a single channel. The QoS approach may then move to another channel in the set of channels it has to choose from and seek to optimize QoS performance over that channel as well. However, current QoS approaches do not attempt to optimize QoS performance across many channels simultaneously by treating the many channels like a single channel for purposes of QoS optimization.

Almost all prior art solutions to the problem of complying with QoS in MANET are applicable only to single channel networks. These approaches can be classified using various known QoS classification schemes. The present application makes reference to the layer-wise classification scheme discussed in more detail by Murthy and Manoj (Ad Hoc Wireless Networks, Architectures and Protocols, 2004, Prentice Hall) with some key modifications in the meaning of QoS frameworks. Simply stated, the layer-wise approach places each MANET QoS technique into one of three major categories: MACIDLL solutions, Network-Layer solutions and QoS Frameworks (cross-layer) solutions.

QoS approaches in the MACIDLL class operate only at the individual link level regardless of the media access method used (TDMA, CDMA, FDMA or other). Network-Layer techniques provide end-to-end support for resource discovery, reservation and provisioning.

QoS Frameworks solutions are much more encompassing and consequently more complex. Multiple layers of the OSI stack work together to deliver the performance level of network services required by the users.

### Single Channel MANET QoS

The Flexible Quality of Service Model for Mobile Ad Hoc Networks (FQMM) discussed by Xiao and Seah (A Flexible Quality of Service Model for Mobile Ad Hoc Networks, Proceedings of the IEEE Vehicular Technology Conference, vol. 1, pp. 445-449, May 2000) is an early attempt at providing QoS for a MANET. The technique disclosed is based on using the basic concepts of Integrated Services (IntServ) and Differentiated Services (DiffServ), both borrowed from wired networking.

IntServ delivers QoS on a per flow basis, whereas DiffServ is class-based. In the classic sense, a flow is the user session between one pair of endpoints in the network. The endpoints may be single nodes, multicast groups or one of each. IntServ requires maintaining detailed state information at each point in the route(s) between endpoints and reserving network resources using the Resource Reservation Protocol (RSVP). IntServ would be extremely difficult to implement in MANET. IntServ is also not very scalable to even medium-sized networks due to the requirement of maintaining state information in real-time.

DiffServ overcomes the scalability problems of IntServ by grouping multiple flows of similar type traffic into a single class and having one class for each large type of traffic type. Thus the number of users is not nearly so important. However, hard-guaranteed delivery of service is not possible with DiffServ.

FQMM is an attempt to combine the strengths of IntServ and DiffServ but exclude their weaknesses. However, several deficiencies still exist with FQMM. One of the major weaknesses with FQMM and all other MANET QoS techniques is that none of them can deliver the required QoS across a dynamic, spectrally non-contiguous set of channels. In addition, FQMM and the other MANET QoS techniques in the prior art are applicable only to single channel networks, not to multichannel—much less noncontiguous multichannel—networks. Besides suffering from low performance in a dynamic, spectrally non-contiguous channel set environment, these techniques cannot deliver hard QoS guarantees and are too power hungry to be deployed by battery-limited devices such as CNRs.

### Multichannel MANET QoS

Techniques of the prior art aim to handle QoS in networks made up of multichannel wireless devices. However, these prior art approaches only handle relatively trivial notions of multichannel networks. Indeed, in a working network the prior art techniques involve transmission and reception of all information over just one channel at a time. In other words, these so-called MANET “multichannel” QoS approaches are just multiple single channel approaches.

One more of the more recent approaches to Multichannel MANET QoS is called “Multi-Channel MAC Protocol for Ad Hoc Wireless Networks” (MMAC) discussed by So and Vaidya (A Multi-Channel MAC Protocol for Ad Hoc Wireless Networks, Technical Report, University of Illinois at Urbana-Champaign, January 2003). MMAC addresses the limitations of wireless networking across an 802.11 set of channels, namely, in which a channel in current use by the radios becomes corrupted or too congested to carry the traffic at the required QoS level. However, the principles used in MMAC are more generally applicable to any type of multichannel wireless network in which the radios can switch from one channel to another as required or directed. MMAC can set up different flows over a local area (within a single hop) to each utilize a separate single RF channel up to the limitations of the radios and the congestion on each channel. However, MMAC only classifies channels as high preference, medium preference and low preference. Most importantly, MMAC cannot manage a single flow that has been spread across multiple channels nor can it account for a dynamically-changing channel set both in number of available channels and in the spectral location of these channels. MMAC also cannot combine multiple fundamental channels into a larger bandwidth channel.

Other so-called “multichannel” techniques exist, but all share the same fundamental limitations pointed out above—they are actually just single-channel selectors/negotiators choosing from a fixed universe of channels each of identical bandwidth. Therefore, there is a need in the art for a QoS approach that is applicable to a multichannel wireless ad hoc network of CNRs.

### SUMMARY OF THE INVENTION

The methods and systems of the present invention enable the provision of QoS over a true multichannel network. Specifically, the QoS framework of the present invention optimizes QoS performance across many channels simultaneously by treating the many channels like a single channel for purposes of QoS optimization.

The Dynamically Transformed Channel Set Quality Of Service (DTCSQ) system of the present invention is a true multichannel selector/negotiator choosing from a generally larger universe of channels to provide QoS services. There is no requirement for each channel to be of identical bandwidth. In some embodiments or applications, all atomic channels may be of identical bandwidth. DTCSQ is a true multichannel framework as it delivers QoS over a network of RF links in which the packets in a flow are transmitted or received over more than one channel regardless of how many carriers are mapped to each channel. Providing QoS over the cognitive radios requires the ability to simultaneously use many tens or more channels as resources for QoS.

Conventional QoS frameworks include a user service model, MAC components, routing, resource reservation signaling, admission control, and packet scheduling. In one embodiment of the present invention, DTCSQ adds to this list the PHY Layer components of the Dynamic Networking Spectrum Reuse Transceivers, discussed in U.S. patent application Ser. No. 12/501,921, which is hereby incorporated by reference. The methodology and system of the present invention may be embodied as a combination of software, hardware, and/or firmware in a cognitive networking radio. The DTCSQ system of the present invention may be defined as the combination of cognitive networking radios that include that software, hardware, or firmware that enable the features disclosed in the invention. A more extensive discussion of the DTCSQ framework is contained in the Description of the Invention section.

### BRIEF DESCRIPTION OF THE DRAWINGS

FIG. 1 illustrates a prior art network architecture in which the DiffServ service is provided;

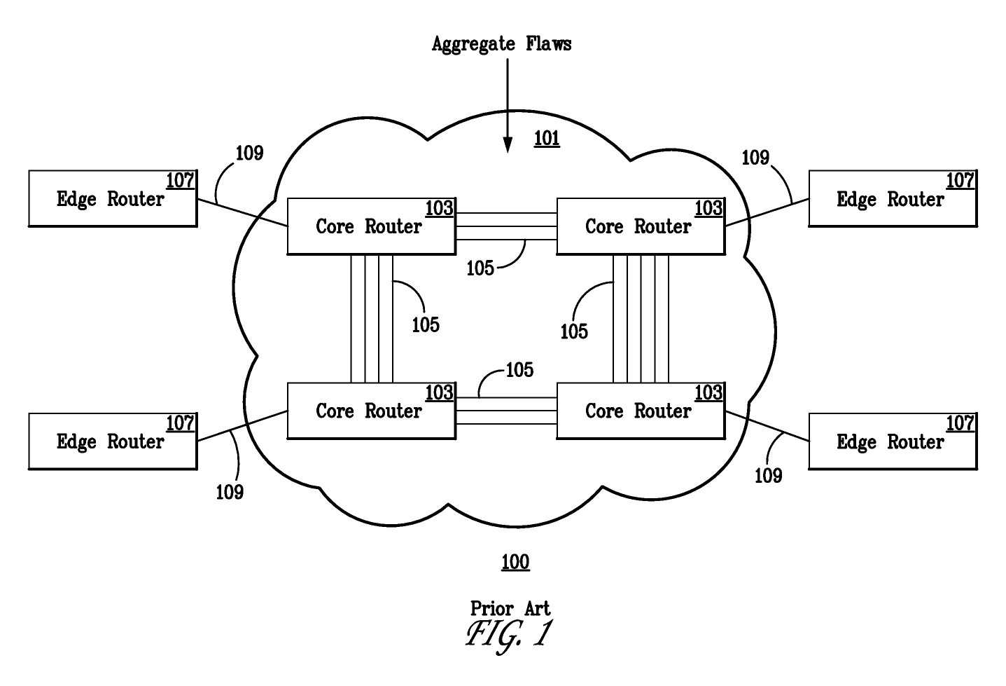

FIG. 2 illustrates exemplary components of a cognitive networking radio in accordance with one embodiment of the present invention;

FIG. 3 illustrates general cognitive radio core functionality and service architecture in accordance with one embodiment of the present invention;

FIG. 4 illustrates exemplary network communications among nodes in a MANET in accordance with one embodiment of the present invention;

FIG. 5 illustrates prior art classification of nodes in a QoS model for MANETs;

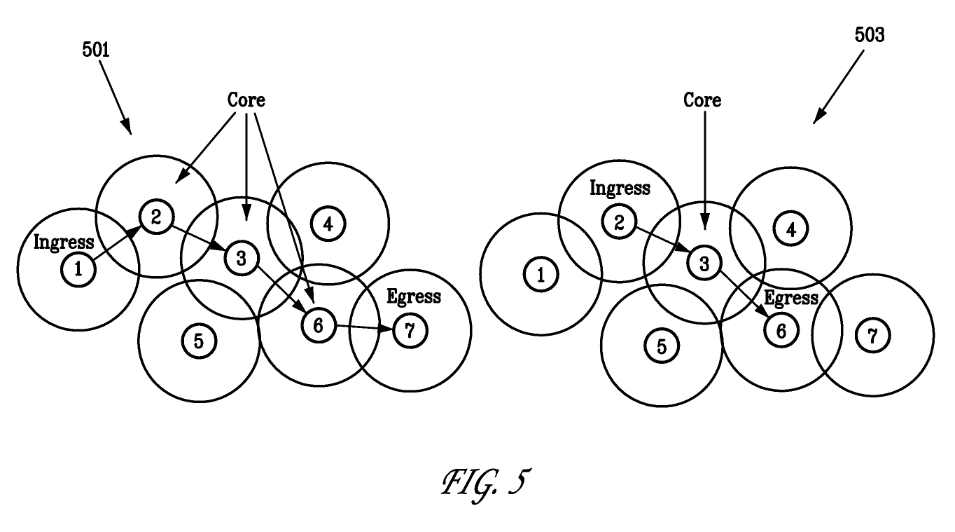

FIG. 6 illustrates the implementation of network protocol functionality by two nodes in accordance with embodiments of the present invention; and

FIG. 7 illustrates an exemplary mapping of functions of the QoS service to the OSI protocol layer in accordance with one embodiment of the present invention.

### DESCRIPTION OF THE INVENTION

### Definitions

This section covers definitions of terms or phrases used throughout the present application in describing the embodiments of the present invention. The DETAILED DESCRIPTION OF THE PREFERRED EMBODIMENTS section includes more detailed discussions of at least some of these terms.

Ad hoc associations/nodes (“A/Ns”)—A/Ns may be defined as nodes in an association within an ad hoc network.

Area—An area in a DNSRT network may be defined by a set of physical coordinates (relative or absolute) or by distance metrics around some point, typically radiating.

Association—An association of nodes may be defined as a grouping of network nodes bound together by a specific relationship or set of rules. Associations' relationships or rule sets may be created using any criteria of importance to the user or network. Relationships and rule sets may change over time and therefore so does the nature of the associations they may be applied to. Associations as a whole within other associations may have a specific relationship to other members of the larger association as well as a different relationship common to the members of the smaller association. A multicast group is an exemplary association.

Atomic Channel (AC)—An atomic channel may be defined as the most basic, smallest, operational channel bandwidth of the CNRs in the network. Wider channels used by the CNRs are multiples of this and are formed from assembling multiple ACs. Examples of ACs are 3.125 KHz, 6.25 KHz, 12.5 KHz, 1.0 MHz, 5 MHz, 20 MHz, 1.0 GHz, etc. The notion of an atomic channel also applies to networks in which at least two (2) of the CNRs are capable of simultaneously operating over channels of which not all are of the same bandwidth and in which some channels of these inhomogeneous channel bandwidth CNRs are not multiples of the smallest channel bandwidth of these CNRs. In that situation, distinct, multiple ACs exist in the same physical network as well as in this type of CNR. For example, this inhomogeneous bandwidth is useful where some CNRs are capable of simultaneously communicating over both relatively narrowband and broadband spectrum regions.

Available Channel (AAC)—An available channel is any channel with atomic channel bandwidth that is not occupied at the time of interest by either a primary user or a higher priority secondary user.

Dynamic Networking Spectrum Reuse Transceiver—A DNSRT may be defined as a cognitive networking radio with spectrum reuse and spectrum discovery functionality such as that of transceivers disclosed in U.S. patent application Ser. No. 12/501,921.

Flow—Flow may be defined as any communication of information from one or more A/Ns to one or more A/Ns in the same network.

Frequency Topology (νT)—The frequency or spectrum topology of a network may be defined as the full set of available frequencies in which some form of allowable RF or wireless communications may occur.
a. Dynamic Frequency Topology (DνT)—DνT may be defined as a frequency topology which changes with time.
b. Heterogeneous Frequency Topology (ηνT)—ηνT may be defined as a frequency topology which changes over a specified physical area of communication for a specified interval of time.
c. Homogeneous Frequency Topology (HνT)—HνT may be defined as a frequency topology which is constant over a specified physical area of communication for a specified interval of time.

Hopping or nodal hopping may be defined as ad hoc message passing.

Knowledge Space—When data has been mapped, or transformed, from being of the type useful for numerical processing to forms that are used by reasoning engines to make decisions, then it is said that information has been transformed from data space to knowledge space. An example of knowledge space is the set of fuzzy logic variables and rules that would be used by a fuzzy logic reasoning engine. Another example is the set of extracted feature vectors in a neural network.

Multi-Association Relay—Spectrum (MARS)—MARS may be defined as a group of nodes, each node in a local A/N within the DNSRT network, that dynamically collects and distributes the spectrum topology to other members of their local A/Ns. A MARS set member is key to the transport of all user and most network control traffic throughout the network. MARS set members communicate with each other and with other nodes or A/Ns. A MARS set member is elected based on the number of available channels that each of its neighbors has available to communicate with other neighbors.

Multipoint Relay (MPR)—A MPR may be defined as one member of the minimum set of nodes required to reach all two-hop neighbors of a given source node that is flooding the network with network topology information. That is, each MPR is a one-hop neighbor of the flooding source and is chosen to “see” the most two-hop nodes from the source. The strict symmetric one-hop neighbor set of each MPR has zero intersection with all other strict symmetric one-hop neighbor sets of its peer MPR set (i.e., there are nodes in the network that are jointly shared by more than one MPR set). MPR is one optimization of the classical link state flooding process, which in any dynamic topology network would quickly overwhelm the network with overhead traffic from flooding.

Neighbor—A neighbor of an A/N may be defined as that A/N which communicates over one or more available ACs. Physical distance need not be directly involved in the specification of what is a “neighbor” although indirectly, the distance between two associations/nodes may have some bearing on this. However, other things such as policy (e.g., FCC spectrum use policy) may prevent communications over certain spectrum which otherwise would make it free for secondary use.

Network Topology—Network topology may be defined as the interconnection layout of the nodes of a network. The most fundamental type of topology in a wireless network is the set of frequencies (spectrum) that any two nodes/associations may communicate over.

Qualified—This term, as used in this application, may be defined as any quantity such as a set of ACs or topology that meets the networking requirements for whatever set of applications the network is being used. These requirements can be security, QoS, battery, mobility or any other category needed to transport control, management, end user data or other traffic across the network.

Quality of Service (QoS)—QoS may be defined as the ability to provide the level of network support to meet any given applications, flows or user requirements. Support includes techniques to manage user priority, data flow performance and network resources (in conjunction with other network services). The ability to deliver any level of QoS carries some degree of uncertainty even for the most stringent approaches. This uncertainty can be expressed in either probabilistic or fuzzy frameworks. In addition to classifying QoS approaches by which network layer(s) and how much network functionality is covered across the layers, each QoS technique can also be further specified with subcategories. Every QoS approach may be described in terms of one or more combinations of categories of QoS.

Strict 2-Hop Neighbor—A strict 2-hop neighbor may be defined as any neighbor of an A/N that is not itself or one of its 1-hop neighbors.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

As will be appreciated by those skilled in the art, portions of the present invention may be embodied as a method, data processing system, or computer program product. Accordingly, these portions of the present invention may take the form of an entirely hardware embodiment, an entirely software embodiment, or an embodiment combining software and hardware aspects. Furthermore, portions of the present invention may be implemented as a computer program product on a computer-usable storage medium having computer readable program code on the medium. Any suitable computer readable medium may be utilized including, but not limited to, static and dynamic storage devices, hard disks, optical storage devices, and magnetic storage devices.

The present invention is described below with reference to illustrations of methods, systems, and computer program products according to embodiments of the invention. It will be understood that blocks of the illustrations, and combinations of blocks in the illustrations, can be implemented by computer program instructions, hardware devices, or a combination of both. These computer program instructions may be provided to a processor of a general purpose computer, special purpose computer, or other programmable data processing apparatus to produce a machine, such that the instructions, which execute via the processor of the computer or other programmable data processing apparatus, implement the functions specified in the block or blocks.

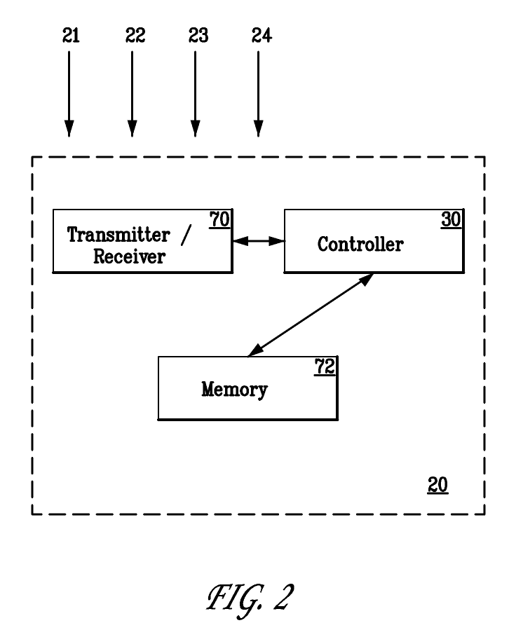

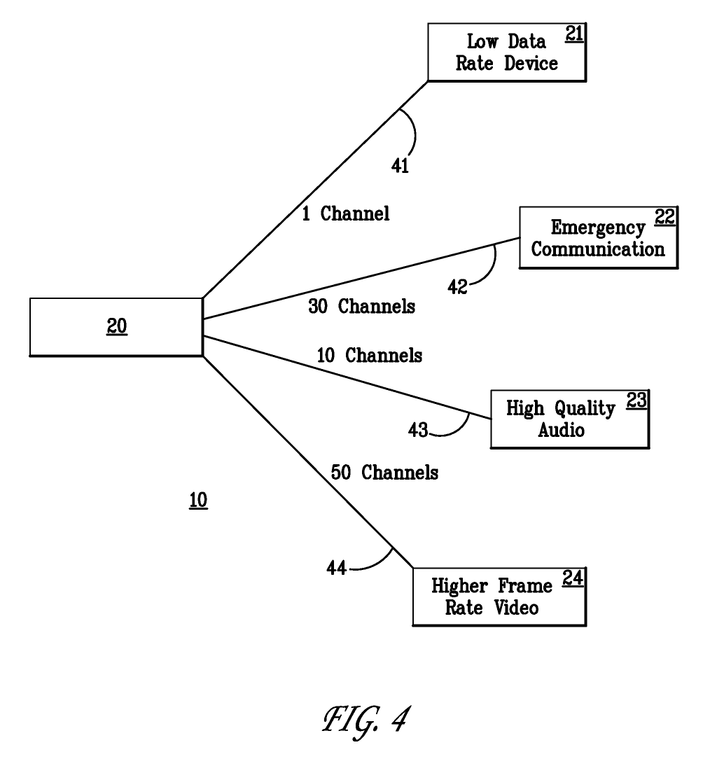

A system aspect of the invention will now be described with further reference to FIGS. 2, 3, and 4. FIG. 4 illustrates an exemplary embodiment of a DNSRT network 10 which may be used to implement the present invention. The network 10 includes has a plurality of wireless mobile nodes 20, 21, 22, 23, and 24, and a plurality of wireless communication links 41-44. The links may be true multichannel, depending on the data delivery requirements of the particular application running in the nodes.

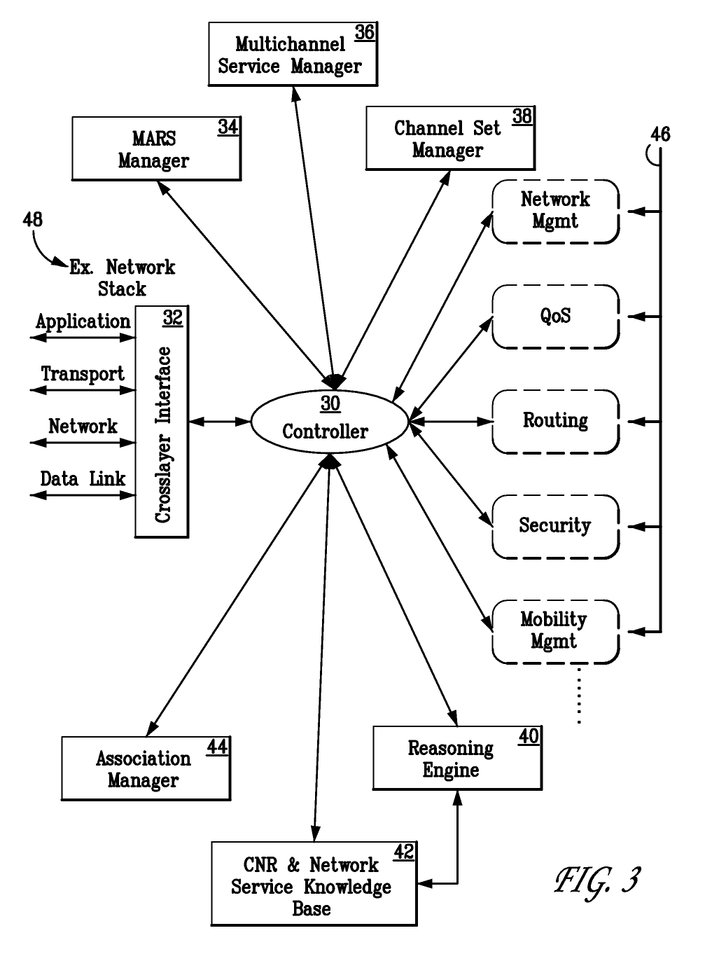

Referring to FIG. 3, each mobile node 20-24 may include a Controller 30 that controls and coordinates the CNR core services; a Cross-layer Interface 32 that the controller 30 uses to communicate with whatever network stack 48 is present with said network stack 48 also outside of the CNR core; a MARS Manager 34 that controls and manages the MARS election process and any subsequent modifications of a given MARS set; a Multichannel Service Manager 36 which distributes any given network service across the available local channel set; a Channel Set Manager 38 which manages and controls the contents of any given local channel set; a Reasoning Engine 40 which accepts inputs coded into such forms as crisp or fuzzy logic, temporal data, etc., and reasons on these inputs over the CNR & Network Service Knowledge Base 42; CNR & Network Service Knowledge Base 42 which contains both Cognitive Networking Radio device information and specific network service information in the forms of pure data and knowledge coded in such forms as IF-THEN rules or temporally-coded data; an Association Manager 44 that manages and controls the contents of local associations. The Controller 30 interfaces with the controllers for the various network services 46 which are outside the DNSRT core (shown in dashed boxes).

Referring to FIG. 2, mobile node 20 includes a controller 30 that has a communications device 70 to wirelessly communicate with other nodes 21-24 of the plurality of DNSRT nodes via the wireless communication links 41-44. Also, a memory 72 may be included as part of the controller 30 or in connection with the controller. In one embodiment each node in the DNSRT network may include a radio such as that disclosed in U.S. Pat. No. 7,457,295 or U.S. Patent Publication No. 20090074033, incorporated herein by reference, programmed to implement the functionality disclosed in the present invention.

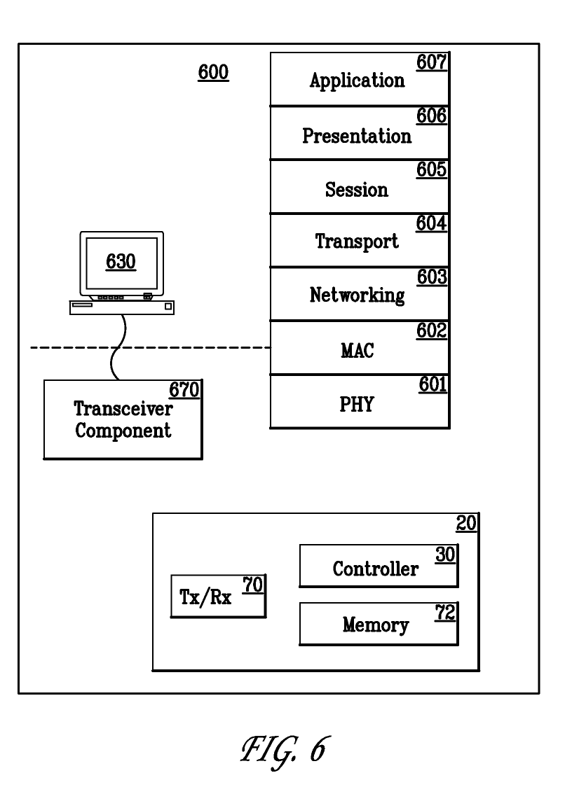

FIG. 6 illustrates two potential implementations of the protocol stack in accordance with two embodiments of the present invention. In the event that a node in the network is a CNR 20, the entire OSI protocol stack 600 is implemented within the CNR. In the event that a node is implemented by the combination of a computer 630 and a transmitter/receiver 670 (e.g., a wireless modem card), the computer 630 may implement layers 602-607 while the transceiver 670 may implement layers 601-602.

The overall QoS service, referred herein as “Dynamically Transformed Channel Set QoS” or just DTCSQ, encompasses multiple traditional network layers above the PHY (fully cross-layer) and may therefore be classified as a QoS framework. Besides the conventional mechanisms such as larger buffers used to support QoS, DNSRT is unique in that it can allocate more than one available channel at any given instant of time for QoS such that all channels involved in the QoS for the given traffic (e.g. a user application flow), are maintained in parallel. DNSRT can also choose the best channels out of the maximum possible to use for any given type of traffic. The DNSRT does not have to choose which channel(s) to use to send traffic over, as this function is associated with network services such as QoS or routing and the interactions of those services with the DTCSNet MACs. A DTCSNet MAC may be considered part of the physical “device.” The interaction of the device and each network service is what provides many of the networking decisions.

A DNSRT device may automatically identify and prioritize the discovered set of channels according to basic PHY Layer QoS metrics dynamically or statically loaded into the device. The DNSRT does not have to handle the queuing of traffic, admission control, signaling and other QoS functions. Also, the DNSRT does not have to directly deal with the prioritization of specific types or classes of traffic, as these are all part of the QoS component itself. The DTCSQ MAC component utilizes the PHY Layer QoS information from DNSRT and then chooses from these available channels the number of channels to be sized for the QoS needed for communications among adjacent A/Ns. Channel sizing in this sense means combing multiple or partial ACs into one or more logical channels called Dynamically Transformed Channel Sets.

### System Capabilities

The DTCSQ framework is applicable to any type of MANET or mesh network and any type of user or system applications. DTCSQ takes particular aim at the multichannel MANET domain where the most difficult networking problems arise. Applications requiring the full spectrum, from best-effort to hard real-time are covered. The following list includes the system-level aspects of DTCSQ.

Dynamic State QoS (DSQ)

Hard State QoS (HSQ)

Soft State QoS (SSQ)

Firm State QoS (FSQ)

Stateful QoS

Hard QoS (HQoS)

Soft QoS (SQoS)

Unlike most other approaches underlying the design of specification of QoS frameworks, the DTCSQ system of the present invention takes the HQoS approach when all QoS requirements must be met, but it may opt for the SQoS approach when not all QoS requirements need be met.

### Dynamic State QoS

The DTCSQ system of the present invention is adaptable depending on whether network resources should or can be reserved and released for the duration of a QoS session. This adaptability is useful for the full range of user applications and system responsiveness requirements. DSQ includes the traditional hard and soft state types of QoS plus a new type of QoS referred herein as “Firm State QoS.”

### Hard State QoS

HSQ pertains to the approach where all network resources along the path from source to destination (source, intermediate nodes/associations and destination) are reserved throughout the entire QoS session. No resources are released for other uses until the session has completed.

### Soft State QoS

SSQ pertains to the approach where only the source and destination of a QoS session are reserved for the session throughout the entire QoS session. Intermediate network resources (associations/nodes) are only reserved when in use within a given time limit. If no activity for that session occurs during that time limit, then the session automatically surrenders that particular network resource. The surrendered resource may be recovered for the given session if needed. No other QoS sessions using that resource are affected as long as they send packets to the resource before that resource timeouts a given session.

### Firm State QoS

FSQ relates to an approach where the following two conditions are met. First, only the source and destination of a QoS session are guaranteed to be reserved for the session throughout the entire QoS session. Second, some intermediate network resources (associations/nodes) behave in a hard state mode, while other intermediate resources behave in a soft state mode. The QoS demands—or system designer sets—the level of firmness for each session or for the system as a whole. FSQ may be considered a gray scale measure of the reservation state of network resources.

### Stateful QoS

Stateful QoS approaches use explicit control mechanisms to discover, track and update the global and/or local topology and flow information. Local tactics only do this for the neighborhood of a single node or association. Global tactics do this on a network-wide scale. Regional tactics are defined as something in between.

Stateless QoS approaches are just the opposite of stateful—they do not update any topology or flow information. Some discovering and tracking may be done, but is not required. Stateless approaches generally only can deliver best-effort service, which is no service guarantees at all.

### Hard QoS (HQoS) and Soft QoS (SQoS)

HQoS requires the QoS requirements to be achieved for the full duration of the session. SQoS does not require the QoS requirements to be achieved for the full duration of the session. Almost all MANET QoS techniques are SQoS because of the highly dynamic nature of these types of networks.

### Architecture

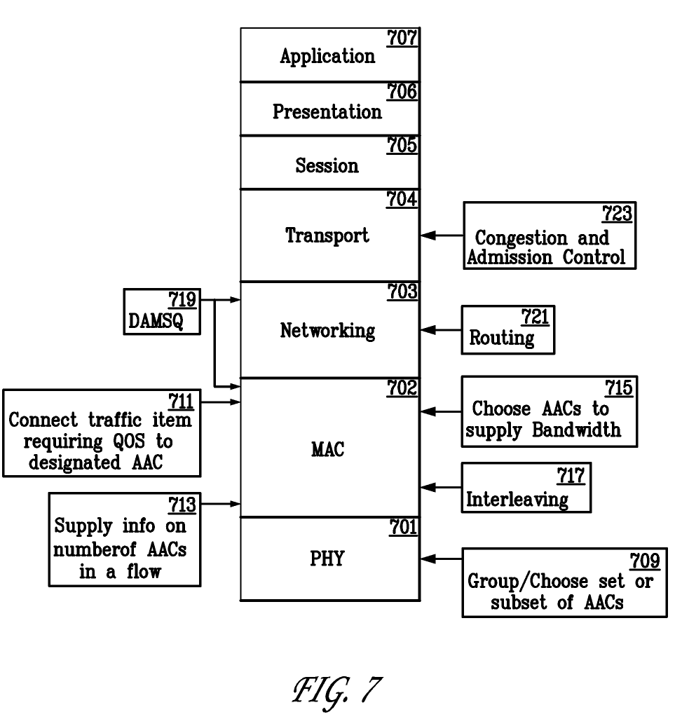

The present invention provides a QoS framework, methodology and specific parameters along with metrics for cross-layer MANET or mesh networking that takes full advantage of the unique spectrum discovery and utilization capabilities of the DNSRT network. A system view of the invention is described with reference to FIGS. 2-4 which illustrate the entities or elements in the network. A layer view of the invention is described with reference to FIGS. 6-7, illustrating how functionality is distributed within the network “stack”. Together, these views provide significant insight into how these components relate to each other and also to how some of the other network services, e.g. routing, interacts with the QoS service.

### Components

DTCSQ's architecture may include several building block components that the network architect can then combine into an architecture appropriate for the given network. In one embodiment, these components are: marking, metrics, metering, channel allocation and queuing, signaling, congestion control, traffic shaping, admission control, and packet forwarding.

### Marking

Packets marked for special treatment by the DTCSQ system of the present invention are further processed and analyzed to determine the type of traffic, the priority and other specified markings that indicate how to handle the traffic relative to both the users' expectations and other traffic types flowing within the network. Any given CNR may mark one or more packets. Packets are marked as they come into the network and may be further marked as they traverse within the network.

IPv4 and IPv6 are two IP protocols adopted by the IETF. The DTCSQ framework looks into fields of either IPv4 or v6 traffic for marked packets. IPv4 traffic has a 3-bit Precedence set in the type of service (TOS) field used for marking IP packets for QoS processing. Standard IPv6 has a much greater capability than IPv4 to support QoS with both the 20-bit flow label and 8-bit Traffic Class (6-bit Diffserv Codepoint and 2-bit Explicit Congestion Notification combined fields). The DTCSQ system of the present invention uses either the IPv4 or v6 fields—whichever is available.

### Metrics

The DTCSQ system makes use of a number of figures of merit, also known in the art as QoS metrics, that are used in the present invention to meter and control traffic to provide the necessary classes of service to the various users of the network. The basic set of metrics may be composed of conventional metrics related to the provision of QoS services (e.g., bit rate, end-to-end packet delay, packet jitter, BER, packet dropping probability, etc.) in addition to others as needed according to the requirements of the network services and user applications.

### Metering

Metering may be defined as the monitoring of the traffic flows to collect data necessary to determine whether the various types of traffic are getting delivered according to user service requirements.

### Channel Allocation and Queuing

The DTCSQ system of the present invention is unique in that it can allocate more than one available channel (AAC) at any given instant in time to meet QoS requirements for one or more flows. In other words, packets from a given flow may be distributed to multiple AACs for transmission. The number of AACs designated by the DTCSQ system of the present invention depends on parameters such as the relative priority of the flow's traffic compared to other flows needing transmission in the same local area of the network. The DTCSQ system of the present invention also chooses the “best” channels out of the maximum possible to use for any given type of traffic or user priority. In one embodiment of the present invention, the maximum possible number of channels is determined by the MARS process. The DTCSQ system of the present invention chooses from the actual available channels the number of channels to be sized for providing the QoS needed for communications among adjacent A/Ns.

There are several factors that can determine the maximum possible channels. It may be a hardware constraint, a spectral constraint, or channel size constraint. True multi-channel radios (radios that broadcast simultaneously a single message on multiple channels) can aggregate together discontiguous channels to create sufficient bandwidth to transmit a signal at a desired bit rate. If a transmission requires, for example, 30 channels out of a possible 500 (hardware or spectral constraint) then 500 is the maximum possible, however not all 500 may be available. The radio then chooses 30 channels that are available to communicate, so as to use the 30 “best” out of the maximum possible. As mentioned, true multichannel refers to the ability to combine the individual channels from a set of available channels into one or more organized channels, resulting in a lesser number of channels, each of equal or greater bandwidth than its constituent available channels. An exemplary system embodying a similar capability is described in U.S. patent application Ser. No. 11/532,306, which is incorporated herein by reference.

Each subset of AACs is assigned in real-time to different intermediate destinations. Intermediate destinations include the following:

Placed into one of several class-based queues;

Sent directly (not queued at all) to one of the network interfaces at the A/N for immediate transmission;

Not transmitted any further, but instead just scanned by the receiving A/N for purposes such as neighborhood metering of general or specific types of traffic. For this intermediate destination, the A/N is promiscuously listening to traffic and possibly collecting statistics concerning the traffic.

In one embodiment, the second intermediate destination above may be considered to be a queue depth of 1 packet (the intermediate destination is set at the head of the queue) and is essentially an emergency override that immediately preempts all other traffic to this interface and indeed to any interface of the A/N. In other words, in this embodiment all the A/N's resources are marshaled to process and transmit this packet. An analogy may be drawn to 911 traffic. Just like in the handling of 911 traffic, great care must be taken to ensure that 911 is not called too often, and is only called when nothing else can prevent a catastrophe (system or user level). In the present invention, the DTCSQ system can manage emergency communications to avoid unnecessary congestion of the network. This may be implemented by marking the packet as a high priority packet, which then forces the packet through the network via HQoS. It can also be done through out-of-band signaling in the hybrid network.

### Signaling

Signaling is used in QoS networks to reserve and release resources. The present invention also includes a hybrid signaling protocol for MANETs.

Proper QoS signaling generally requires the reliable transfer of signals between routers and the correct interpretation and activation of the appropriate mechanism to handle the signal. That is, the signaling sent by routing nodes within a network has to be understandable and implemented by the rest nodes. The communication of these signals between routers can be implemented as “in-band signaling” and “out-of-band signaling.” In-band signaling may be defined as the encapsulation of network control information in the data packets, thus resulting in a lightweight signaling framework. Out-of-band signaling may be defined as the use of specially designated control packets used exclusively for communicating control information.

In the present invention, for any given flow, multiple AACs may be used to transport the traffic of a single flow. As is well-known in the field of mobile networking, flows requiring guaranteed service must be controlled using out-of-band signaling. The downside to this is that out-of-band signaling takes up much more overhead than in-band signaling. Judicious use of guaranteed service will therefore reduce the network overhead. Flows requiring fewer or no service guarantees are better controlled using in-band signaling. In-band signaling is always preferred when service levels permit.

The DTCSQ system of the present invention implements a third class of signaling referred herein as Hybrid Signaling that is also available to the network. Hybrid signaling is used for network traffic that must be guaranteed part of the time or along part of the path, but not the rest of the time or rest of the way from source to destination. The transition from one class of signaling to another may be either pre-specified or automatically determined by the network during execution. For example, in getting traffic from source to destination, it may be determined that using out-of-band signaling along the entire path will require too many resources and slow other parts of the network down too much. However, the DTCSQ system may traverse other parts of the network in a lower priority manner.

Hybrid signaling is most practical when some intermediate resources hold up or act like a post office and queue traffic for some longer period of time before sending it on. This store-and-forward approach may affect the delay and jitter metrics for QoS. The more efficient use of resources is achieved using SQoS, however at times any one node may be backed up or holding less urgent messages in a queue so the network uses out-of-band signaling to by-pass the queue, thus a higher state QoS is achieved in moving the packet through the network.

The following example illustrates the usefulness of hybrid signaling. The first packets of a given flow have just been transmitted from the source. Because of the history of link instability in certain areas of the network, hard state QoS is required at the initial edge of the network (an intermediate node). Out-of-band signaling is thus applied from source to the current edge of the network. Once at this edge of the network, packets of the flow have then arrived at a node that can “wait” for retransmission to the next hop until at least another node arrives in its area. This intermediate node is effectively a temporary postal box holding place. When this traffic can be sent on to the next hop in the route to the destination, there is not as much haste or concern for how long it will take before they are retransmitted. This means that soft state QoS can be applied at that time until the packets reach their destination, resulting in optimization of the use of network overhead under the constraint that the flow must get to its destination within some moderately wide latitude of when it will arrive. This latitude is tied to the packet delay QoS metric.

The signaling can be applied to any type of QoS metric, which may be determined by the systems designer as the metric or metrics to measure success on. In soft state QoS, the network has wide freedom in passing packets.

In a true multichannel environment, packets of a single flow are often distributed among many spectral channels. Additional complexities come into play due to the mobility of nodes associations, noisy links and security or billing restrictions on the usability of various links. Forwarding and routing the packets of a single flow under these conditions in which all packets must be treated with the same service level requires in-band signaling.

### Congestion Control and Queue Management

Congestion control detects the presence or anticipated buildup of packets that are not being able to be sent to their destination. As traffic is received by the A/N, it is queued using the DTCSQ Dynamic Associative Multi-Spectral Queuing (DAMSQ) scheme (unless it is emergency traffic).

The DTCSQ system of the present invention uses the standard IP ECN mechanism to notify the source that congestion of its traffic is occurring or has occurred along the path(s) to its destination. The local A/N queue management for intermediate and destination A/Ns set the ECN bits, but need not notify the source directly. Instead, the notification may be sent to the A/N's local network manager to mark the affected channels as likely not to be available soon. This is a unique difference in how the ECN bits are used by the DTCSQ system of the present invention and how they are used in other networking approaches. The unavailability of the channel and the reason why it is not available (e.g., congestion) can then be discovered by a combination of the MAC Layer and PHY Layer during the AAC discovery process of the radio. The AAC discovery process of the radio may be implemented as disclosed in U.S. Pat. No. 7,457,295 or U.S. Patent Publication No. 20090074033, both of which are incorporated herein by reference.

### Dynamic Associative Multi-Spectral Queuing (DAMSQ)

Dynamic Associative Multi-Spectral Queuing is a major new queuing invention specifically created for use in a multichannel networking environment and introduced as part of the DTCSNet framework. DAMSQ may be used for a number of network-oriented components such as congestion management and scheduling. Critical differences in DAMSQ and its closest competing method, Class-Based Queuing (CBQ), are outlined in the following paragraphs.

The following constitute the main characteristics of DAMSQ. Groups of CNRs may be linked together using special constructs, for example, the groups may be formed using system-specified combinations of spectral channels, IP addresses, MAC addresses, application types, A/Ns and protocols. The system-specified combinations are pre-configured or dynamically grouped using user/network application requirements. Each combination is bound together by a construct called a group construct (not the same as an association of nodes). The group construct is fully specifiable by the user, system engineer, network architect or other entity (e.g., a network control program, a government entity or an external mandated database). DAMSQ's dynamic nature arises from its ability to change the membership of any given group or the group construct binding the group members (i.e., CNRs) together. Groups may either be hierarchical or flat. DAMSQ may operate at either Layer 2 or Layer 3 and may use the well-known Weighted Fair Queuing (WFQ) with dynamic weight control. For example, if DAMSQ is using Layer 3 information such as IP addresses, then it is said to be operating at Layer 3. If DAMSQ is using Layer 2 information such as MAC addresses, then its operating at Layer 2. DAMSQ may also be operating at both layers simultaneously if the information it is using to form its associations is supplied from both layers.

DAMSQ is optimized for use in dynamic wireless networks with emphasis on MANET and mobile mesh. Therefore, it can and should be implemented not only at the edge of a network, but also in its interior.

Conventional Class-Based Queuing (CBQ) was developed by the Network Research Group at Lawrence Berkeley National Laboratory and subsequently placed into the public domain as open source material. Their CBQ technology allows the network architect to create a hierarchy of classes based on system-definable combinations of protocols, IP addresses and application types. Several companies have implemented or created new inventions using variations of this queuing scheme (e.g., Cisco, Motorola). The general use is at the edge of a wide area network (WAN). CBQ also doesn't understand anything about spectral channels, especially a true multichannel network. Cisco has implemented a version of CBQ that uses WFQ. DAMSQ is not WFQ, but instead makes use of it to enable different sessions to be granted varying levels of service resources depending on the current weight assigned to the session and its associated queue(s).

While queuing (scheduling for traffic processing) is very developed for cellular (including dynamic, but still single channel systems) and wired networks, it has never been developed for true multichannel networks especially with MANET and mobile mesh topologies. The true multi-channel nature of DNSRTs, for example, enables the merging of signaling methods in one platform.

### Traffic Shaping

In one embodiment, traffic shaping (also called packet shaping) in the DTCSQ system of the present invention occurs at every A/N in the network whether source, destination or intermediate A/N. Traffic shaping may be defined as adjusting the rate and pattern at which packets are transmitted by a given A/N. The DTCSQ system of the present invention allows traffic shaping to occur on either individual flows (IntServ-like) or on coarse-grained classes (DiffServ-like) whether multiplexed (interleaved) or not. The particular method for traffic shaping by the DTCSQ system of the present invention closely interfaces any standard/conventional bandwidth throttling or rate limiting method with the average of the set of AACs over a traffic-determined period of time to properly control the traffic flow.

### Admission Control

Admission control ensures as much as possible that the introduction of new traffic flows into the transmission or queuing mechanisms does not degrade the current QoS. Some traffic, such as the 911-class traffic has to be allowed to preempt active traffic of lower priority. For MANET, the DTCSQ admission control is applied at every node of the network and not just at the edges as is conventionally done. The reason for this is that a MANET's “edge” can be difficult-to-impossible/impractical to determine since the topology is very dynamic. An exception to this would be if only a given subset of A/Ns in the MANET were allowed to introduce new traffic flows. The particular admission control technique adopted is not crucial to the proper implementation to the DTCSQ system of the present invention.

### Packet Forwarding

The DTCSQ system of the present invention may use whatever mechanisms are in place in the network and software. For example, routing is used by the DTCSQ system for internode forwarding. Internal software mechanisms, such as software buses, are used to forward packets to other processes residing in the node. It is necessary to use routing for the general case of intra-association packet forwarding.

### Layers

In general, DTCSQ may be described as a “cross-layer” QoS approach. Referring to FIG. 7, in one embodiment of the present invention the DTCSQ framework implements functions, each function having components in different layers, for example, the PHY 701, MAC/data link 702, Networking 703, and Transport 704 layers of the OSI model. FIG. 7 also illustrates the Application (707), Presentation (706), and Session (705) layers. Not only may the DTCSQ's components be distributed among the network layers, some of these components interact in a cross-layer manner with other DTCSQ components. For example, if Transport Layer Admission Control needs information from the MAC Layer such as number of AACs being combined for a given flow, then that information is made available (713) as needed.

The DTCSQ system of the present invention encompasses functions essential and common to most any useful QoS framework: signaling, packet forwarding, admission control, routing, packet scheduling and MAC Layer processing to access the available medium efficiently. PHY Layer considerations are absorbed into DNSRT devices if present. Otherwise, the MAC Layer makes some assumptions as to the validity of the required data (the set of ACCs) that it needs. Finally, each successive network layer may use a different set of QoS metrics to process the traffic. In general, any given QoS metric will only be utilized by a single layer.

In one embodiment of the present invention, MARS is the mechanism used for the optimized forwarding or distributing of traffic at the MAC and Network layers. All other things being equal, choosing the largest set of available atomic channels in the band(s) that the CNR radios are operating in for every MARS A/N ensure the highest probability of traffic flow with the desired QoS from the source to the destination. The following subsections overview the QoS components at each layer.

### PHY Layer

The physical layer (PHY Layer) of the DTCSQ system of the present invention chooses the subset of AACs that the MAC gives access to a set of channels. PHY QoS uses selected QoS metrics to choose this subset. The DTCSQ PHY layer also groups the AACs into subsets, or clusters, of AACs having significant similarity (709).

For example, noise level is one characteristic that may be used for AAC clustering at the PHY Layer. Assuming that the DNSRT chooses 40 viable channels for the current subset of AACs, if the noise floor is very similar for 10 of the 40 channels, then these 10 channels may be subgrouped by the DTCSQ PHY for the MAC to then use for access by various types of traffic that can still deliver required performance at these noise levels. Without additional significant processing, possibly real-time degrading reasoning, it would not make much sense for the MAC to choose 8 of these 10 channels to supply the bandwidth needed by a given flow, but then handicap the supplied bandwidth with some of these channels that are too noisy to perform with the bit rate and BER's needed by the whole flow. One of the aspects of the present invention is the use of DNSRT to allow meeting QoS requirements by controlling the transmission of data over the multiple channels.

The exception to this is a “best-effort” service or very low QoS, which is all that is needed. This may or may not be characterized as a network service at all.

### DTCSQ MAC Layer

The primary purpose of a MAC layer is to give a communications user's traffic controlled access to the physical medium being used. Using MAC Layer QoS metrics, the DTCSQ MAC connects each traffic item requiring QoS to one of the subsets of AACs designated by DTCSQ PHY as being QoS similar enough to be used by the MAC (711). At this layer, DTCSQ applies the link-level QoS metrics (bit rate, BER, jitter, delay, packet loss, etc) to each candidate channel after monitoring the channel for some given number of samples. How many samples are used is dependent on the given metric, the recent history of measurements of the metric and other factors, as would be appreciated by a person of ordinary skill in the art.

DTCSQ MAC logically fuses multiple AACs from the same subset of PHY-level characteristics into one or more larger bandwidth channels in order to meet the bandwidth requirements (715) of the various types of traffic flowing through the local area of links. If the network is entirely composed of DNSRTs, then the identifications of the AACs and subsets of AACs with similar PHY Layer QoS quality are absorbed into the physical operation of this radio. If radios without this capability, (which should always be the case for non-DNSRT devices), are included in part or whole in the network, then whenever non-DNSRT radios are monitoring the medium, these subsets of AACs are delivered to the DTCSQ MAC Layer through other significantly more limited mechanisms such as a manual entry, reading of pre-configured files, etc. When non-DNSRT devices are used in the network, the responsiveness, accuracy and dependability of the reporting of the AAC set cannot be guaranteed unless the AAC set will remain constant throughout the operational lifetime of the network.

Another DTCSQ MAC function is complimentary to the function combining AACs to meet bandwidth requirements. Instead of combining or fusing whole AACs to meet bandwidth requirements, this function multiplexes lower bandwidth traffic flows over this link to better utilize the available local area channel set. The multiplexing may be either one contiguous block per flow or interleaved flows (717). Interleaved flows may be implemented by any distribution scheme such as using a round robin scheme to take one packet at a time from each flow and multiplexing the next packet from the next flow. This process may be continued until all packets are sent from each flow unless interrupted by another event, for example, an event that disrupts or requires a change in the flow of packets, such as a 911 call. Interleaving may be rigidly configured or adaptive according to user criteria such as traffic type, as appreciated by a person of ordinary skill in the art. Individual flows may be given higher priority by virtue of inserting more successive packets from a given flow before inserting the next packet from a lower priority flow.

ACs within the channel set universe may be pre-partitioned according to the traffic type. This can be either beneficial or detrimental depending on the expected use of the network. It may be desirable to set aside certain regions of the ACs for carrying traffic that will require certain frequencies for better performance. However, such reserving of portions of the spectrum would more likely to be considered as too restricting of the choices for channel usage.

### DTCSQ Network Layer

The DTCSQ system of the present invention interacts with its DTCSNet routing companion to find routes (721) and forward traffic according to the QoS requirements of each packet and flow. The routing protocol, Dynamically Transformed Channel Set Routing (“DTCSR”) is discussed in U.S. Provisional Patent Application No. 61/121,797, incorporated herein by reference. Many MANET routing techniques can be used in single channel networks. However, attaining and maintaining service level in a real-time dynamically-changing multichannel network requires a routing method that enables the rerouting of traffic of any type in accordance with the QoS requirements across any subset of the AACs.

DAMSQ can be implemented at the networking 703 and the MAC 702 layers.

### Transport Layer

Mechanisms that come into play at the Transport Layer include the congestion control and admission control mechanisms 723. These two mechanisms control both the admission of a flow into the MANET from any A/N in the network and congestion at any A/N.

### Protocols

If the present invention is implemented within a network of DNSRTs, the network implements the following protocols associated with the network functioning and configuration:
DNSRT Initialization Protocol (DILP)—This protocol is associated with initial configuration and activation of the DNSRT network including initially configuring each DNSRT plus any other attached devices such as non-DNSRT gateways. Information used for initializing the network may include decision metrics, decision parameters, preconfigured routes (static or dynamic), node addresses, spectrum operating parameters, A/N metrics and parameters.
DNSRT QoS Control Protocol (DQCP)—DQCP is a protocol associated with handling Quality of Service control in a DNSRT network. This protocol is responsible for reserving/unreserving network resources, controlling the number of flows into areas of the network, setting bits in protocol headers governing QoS, etc.
DNSRT QoS Management Protocol (DQMP)—DQMP is a protocol associated with handling Quality of Service management in a DNSRT network. This protocol carries queries for monitoring the actual QoS performance through different devices and configures each device with the required QoS parameters such as the metrics for each class of service supported by a given device.
DNSRT MARS Control Protocol (DTCSP)—DTCSP is a protocol associated with handling MARS control in a DNSRT network. This protocol is responsible for issuing requests to one-hop neighbor A/Ns to collect and send their available spectrum information to the requesting A/N. The expected information to be received by the requestor includes a combination of the number of atomic channels along with contiguous channel maps. This protocol may also send out to other neighbor A/Ns the identities of the elected MARS A/Ns for that particular source A/N.
DNSRT MARS Management Protocol (DMMP)—DMMP is a protocol associated with handling MARS management in a DNSRT network. This protocol carries queries for monitoring the status of a MARS A/N and its member A/Ns (nodes, associations of nodes or associations of associations).
DNSRT Security Control Protocol (DSCP)—DSCP is a protocol associated with handling Security Service control in a DNSRT network. This protocol is responsible for reserving/unreserving network resources, controlling the number of flows into areas of the network, setting bits in protocol headers governing QoS, etc.
DNSRT Security Management Protocol (DSMP)—DSMP is a protocol associated with handling Security Service management in a DNSRT network. This protocol carries queries for monitoring the actual QoS performance through different devices and configures each device with the required QoS parameters such as the metrics for each class of service supported by a given device.
DNSRT Routing Control Protocol (DRCP)—DRCP is a routing master protocol associated with handling Routing Service control in a DNSRT network. This protocol is responsible for reserving/unreserving network resources, controlling the number of flows into areas of the network, setting bits in protocol headers governing QoS, etc.
DNSRT Routing Management Protocol (DRMP)—DRMP is a routing master protocol associated with handling Routing Service management in a DNSRT network. This protocol carries queries for monitoring the actual QoS performance through different devices and configures each device with the required QoS parameters such as the metrics for each class of service supported by a given device.
DNSRT Network Management Control Protocol (DNCP)—DNCP is a protocol associated with handling Network Management Service control in a DNSRT network. This protocol is responsible for reserving/unreserving network resources, controlling the number of flows into areas of the network, setting bits in protocol headers governing QoS, etc. DNSRT is not realized in just a MANET routing, QoS or any other network service or device. DNSRT is realized in a cross-layer radio device that takes a broad, network systems approach and whose core functionality off-loads some of the tasks of routing and other network functionality/services in a fundamentally new network service-agnostic set of cognitive networking radio core functions. These core functions are pushed down into the PHY and MAC Layers—the lower the better. What DNSRT does for MANET (also mesh, sensor, etc) services is to simplify and speed up those network services by tapping into the native spectrum discovery and allocation capabilities of various cognitive radios. Some CRs with such capabilities are more advanced than others and may provide the underlying technology base that allows fuller implementations of DNSRT.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of operating an ad hoc wireless network comprising:
at the physical layer of a node, selecting a set of available atomic channels based on noise level metric;
at the node, receiving a quality of service requirement over a plurality of true multichannels; connecting traffic with the required quality of service to the set of available atomic channels.
